(19) United States
(12) Patent Application Publication
(10) Pub. No.: US 2026/0279215 A1
(43) Pub. Date: Sep. 17, 2026

(54) Hybrid Interactive Virtual Environment System and Method of Use Thereof

(71) Applicant: The Hong Kong Polytechnic University, Hong Kong (CN)

(72) Inventors: Wee Yee Shara LEE, Hong Kong (CN); Chi Fung Jerry CHING, Hong Kong (CN); Ka Wai Helen LAW, Hong Kong (CN); Wan Shun Vincent LEUNG, Hong Kong (CN)

(21) Appl. No.: 19/469,025

(22) PCT Filed: Mar. 29, 2024
(86) PCT No.: PCT/CN2024/084712

§ 371 Date: Sep. 25, 2025

Related U.S. Application Data
(60) Provisional application No. 63/456,323, filed on Mar. 31, 2023.

(51) Int. Cl. G09B 5/06; G06F 3/01; G06T 3/08; G06T 3/18; G06T 19/00; H04N 9/31; H04R 5/02

(52) U.S. Cl. CPC G09B 5/067; G06F 3/011; G06T 3/08; G06T 3/18; G06T 19/006; H04N 9/3147; H04N 9/3185; H04R 5/02; H04R 2205/024

(57) ABSTRACT

A Hybrid Interactive Virtual Environment (HiVE) system and a method of use thereof are provided, said system and method are configured for clinical education and training. Said system comprising: an immersive room, which is 6-sided Cave Automatic Virtual Environment (CAVE) platform and is configured to a fully immersive interactive hybrid classroom; an image generator, which is configured to process input contents and render the input contents in either two dimensional (2D) mode or three dimensional (3D) mode to generate interactive contents for clinical education and training; a projection warping system to perform a process of projection warping and blending to generate a projection warped display image; and a video processing system to process the projection warped display image to generate a frame-synchronized display output; wherein the immersive room comprises a surround sound system to produce audio output to the interactive contents, a motion capture system to produce tracking information of the users inside the immersive room and send the tracking information to the interactive contents, and projectors to project the frame-synchronized display output from the video processing system to generate a 3D interactive image within the immersive room for clinical education and training, such that users in the immersive room may watch and listen to the 3D image and interact with the 3D image and/or with each other for clinical education and training.

### RELATED APPLICATION

The present application claims the benefit of U.S. Provisional Patent Applications Ser. No. 63/456,323 filed on 31 Mar. 2023. The disclosures of this provisional application are incorporated by reference herein in their entirety.

### TECHNICAL FIELD

The present application generally relates to a Cave Automatic Virtual Environment (CAVE) technology and, more specifically, to a Hybrid Immersive Virtual Environment (HiVE) system adopting a fully immersive CAVE and a method of use thereof, for practical and collaborative learning.

### TECHNICAL BACKGROUND

A cave automatic virtual environment (also known by the recursive acronym CAVE) is an immersive virtual reality environment where projectors are directed to between three and six of the walls of a room-sized cube. A CAVE is typically a video theater situated within a larger room. The walls of a CAVE are typically made up of rear-projection screens or large-scale LED displays. The floor of a CAVE can be a downward-projection screen, a bottom projected screen or a flat panel display. The projection systems are very high-resolution due to the near distance viewing which requires very small pixel sizes to retain the illusion of reality. The user wears 3D (three dimensional) glasses inside the CAVE to see 3D graphics generated by the CAVE. People using the CAVE can see objects apparently floating in the air, and can walk around them, getting a proper view of what they would look like in reality to view and/or study it from all angles. A CAVE user's movements are tracked by the sensors typically attached to the 3D glasses and the video continually adjusts to retain the viewers perspective. Computers control both this aspect of the CAVE and the audio aspect. There are typically multiple speakers placed at multiple angles in the CAVE, providing 3D sound to complement the 3D video. To be able to create an image that will not be distorted or out of place, the displays and sensors must be calibrated. The calibration process depends on the motion capture technology being used. Optical or Inertial-acoustic systems only require to configure the zero and the axes used by the tracking system. Calibration of electromagnetic sensors (like the ones used in the first cave) is more complex. In this case a person will put on the special glasses needed to see the images in 3D.

The current practice in clinical education and training mainly involves clinical placement which is highly restrictive regarding its logistical and teaching aspects. The major pre-clinical training and placement supplementary material includes videotaped virtual hospital visits. However, it fails to facilitate students' spatial sense development required for establishing a safe and efficient working manner in a complex occupational environment involving various clinical equipment and hazards. Video-taped virtual visits deprive students of hands-on experience as there are no interactive components. Video-taped virtual visits deprive students of human-to-human interaction as students would not need to interact and communicate with each other during the virtual visit.

Today, CAVEs are used for research in a range of disciplines, but are not utilized for clinical education and training.

In another aspect, the increasing number of paediatric cancer diagnoses worldwide underscores the urgent need for more effective, child-specific treatment protocols that address the unique challenges of treating cancer in children.

Conventional cancer treatments, such as chemotherapy and radiation, often come with severe side effects that can impact a child's development, quality of life, and long-term health, and hence have adverse effects of cancer treatments. Besides, the emotional and psychological toll of cancer treatment on young patients and their families necessitates innovative care strategies that support mental and emotional well-being alongside physical health, to avoid adverse psychological impact.

Children's varying responses to cancer treatment highlight the importance of personalised medicine, and need for personalised care. Tailored treatment plans can improve outcomes by considering the individual genetic makeup, type of cancer, psychological needs, and overall health of each paediatric patient. In radiotherapy, the need of repetitive general anaesthesia (GA) for paediatric patients due to the need for complete immobilization during treatment, presents risks of developmental complications and adds to the emotional distress of patients and families. A notable gap in comprehensive support services for children undergoing cancer treatment and their families calls for innovative solutions. These services should address not only the medical needs but also the psychological, educational, and social support required throughout the treatment journey.

Therefore, there is also a pressing need for innovative care in paediatric radiotherapy, in which HiVE is an excellent platform to conduct educational workshops and rehearsals for children cancer patients and their caregivers for psychological, educational and social support.

### SUMMARY OF THE INVENTION

It is an object of the present invention to provide a system of hybrid immersive virtual environment (HiVE) adopting a fully immersive CAVE for practical and collaborative learning, especially for clinical education and training.

According to an aspect of the present invention, a Hybrid Interactive Virtual Environment (HiVE) system which is configured for clinical education and training is provided, comprising: an immersive room, which is 6-sided Cave Automatic Virtual Environment (CAVE) platform and is configured to a fully immersive interactive hybrid classroom; an image generator, which is configured to configured to process input contents and render the input contents in either two dimensional (2D) mode or three dimensional (3D) mode to generate interactive contents for clinical education and training; a projection warping system to perform a process of projection warping and blending to generate a projection warped display image; and a video processing system to process the projection warped display image to generate a frame-synchronized display output; wherein the immersive room comprises a surround sound system to produce audio output to the interactive contents, a motion capture system to produce tracking information of the users inside the immersive room and send the tracking information to the interactive contents, and projectors to project the frame-synchronized display output from the video processing system to generate a 3D interactive image within the immersive room for clinical education and training, such that users in the immersive room may watch and listen to the 3D image and interact with the 3D image and/or with each other for clinical education and training.

Preferably, in the process of projection warping performed by the projection warping system, the input contents on the image generator are rendered and arranged based on the physical layout of a projection surface of the projectors, and then warping is done based on the rendered display layout then further processed, rearranged, and distributed to each projector; wherein when running 2D mode with projection warping and blending, the entirety of pixel assigned to each projector are displayed by the projector directly, and when running in 3D mode, the image generator render images for both the left and the right eye of the user, and arranged in side-by-side manner as final output to send to the video processing system.

Preferably, in the immersive room, the projectors for walls are installed inside the space on the ceiling area as front, back, left, and right projectors, a set of custom-made projector cover structure is installed around the projectors to conceal the projectors while allowing light from the ceiling projectors to project onto them; projectors for the ceiling are installed behind the left and right walls outside of the space, an opening matching the shape of the projection light frustum is carved out on the wall for each projector to allow light to pass through while minimizing the impact to immersion; and projectors for the floor are installed on top of the ceiling wall and projected onto the floor through opening on the ceiling carved out in the same manner as the ceiling projectors.

Preferably, a plurality of calibration cameras with fisheye lens are placed strategically inside the immersive room and connected to the Image Generator to facilitate projection warping and blending.

Preferably, to add interactivity to the system, the motion capture system comprises a plurality of motion capture or sensing devices using optical or infrared light mechanism which are installed at strategic locations inside the immersive room under or near the ceiling of the immersive room.

Preferably, the immersive room is created inside a structural room using drywall, partitioning the structural room into the immersive room for the fully immersive interactive projection system and an additional room or space for storage, concealment of relevant hardware equipment or device, or for any other purposes, wherein each side wall of the drywalls on the left and right side of the immersive room consists of two segments: a vertical lower segment and an internally tilted upper segment, wherein the upper segment of the side wall is tilted inward at an angle that closely matches the light path of the bottom of the projector's projection frustum, such that the immersive room is 6 sided comprising a ceiling, a floor, two vertical segments and two internally tilted upper segments.

Preferably, the system further comprises cameras to take a 360-degree photograph of the immersion room during clinical education and training, and the projectors are capable to display 360-degree images obtained in different clinical settings.

Preferably, the system further comprises goggles and handsets to be used by users to interact with the 3D interactive image and to interact with each other during clinical education and training.

Preferably, the system can be switched among different teaching modes to meet different learning objectives in a teaching session during clinical education and training, wherein in one of teaching mode, the immersion room is used as a conventional class.

Preferably, real physical objects can be placed in the immersion room, and the system integrates virtual objects of the 3D image and the real physical objects to facilitate realistic simulation.

According to another aspect of the present invention, a method for creating Hybrid Interactive Virtual Environment (HiVE) and configured for Clinical Education and Training is provided, comprising: forming an immersive room by a 6-sided Cave Automatic Virtual Environment (CAVE) platform so as to configure it into a fully immersive interactive hybrid classroom; inputting or saving contents for clinical education and training into an image generator positioned in the immersive room, wherein the image generator is configured to process the input or saved contents and render the contents in either two dimensional (2D) mode or three dimensional (3D) mode to generate interactive contents; performing a process of projection warping and blending by a projection warping system, to generate a projection warped display image; and processing the projection warped display image by a video processing system to generate a frame-synchronized display output, wherein the immersive room comprises a surround sound system to produce audio output to the interactive contents, a motion capture system to produce tracking information of the users inside the immersive room and send the tracking information to the interactive contents, and projectors to project the frame-synchronized display output from the video processing system to generate a 3D interactive image within the immersive room for clinical education and training, such that users in the immersive room may watch and listen to the 3D image and interact with the 3D image and/or with each other for clinical education and training.

Preferably, during the process of projection warping by the projection warping system, the input contents on the image generator are rendered and arranged based on the physical layout of a projection surface of the projectors, and then warping is done based on the rendered display layout then further processed, rearranged, and distributed to each projector; wherein when running 2D mode with projection warping and blending, the entirety of pixel assigned to each projector are displayed by the projector directly, and when running in 3D mode, the image generator render images for both the left and the right eye of the user, and arranged in side-by-side manner as final output to send to the video processing system.

Preferably, to add interactivity to the system, the motion capture system comprises a plurality of motion capture or sensing devices using optical or infrared light mechanism which are installed at strategic locations inside the immersive room under or near the ceiling of the immersive room.

Preferably, the method further comprises using cameras to take a 360-degree photograph of the immersion room during clinical education and training, and displaying 360-degree images obtained in different clinical settings by the projectors.

Preferably, the method further comprises integrating real physical objects and virtual objects of the 3D image in the immersion room to facilitate realistic simulation during clinical education and training.

Hybrid Interactive Virtual Environment (HiVE) is a large-scale XR hybrid classroom with fully immersive CAVE technology allowing tailor-made clinical simulation, clinical skills execution, collaborative education (student number between 20 and 40), human-to-equipment and human-to-human interaction for collaborative learning in clinical education and training.

The present system of Hybrid Interactive Virtual Environment for Clinical Education and Training is an innovative experiential learning environment. To effectively translate knowledge into clinical practice, students must gain a thorough understanding through practical application. The system utilizes the Cave Automatic Virtual Environment (CAVE) technology to provide students with a highly immersive and realistic environment that replicates actual clinical sites, incorporating real equipment and spatial representation. By using this innovative technology, students can practice skills and better prepare for clinical training in hospitals. This technology provides a safe and ‘fault-tolerant’ atmosphere for students to engage in different scenarios, such as routine and emergency situations. The CAVE technology not only creates a realistic clinical environment but also promotes peer learning by enabling up to 30-40 students to interact with each other and the virtual environment. Most importantly, the vivid visualizations and interactive elements in the CAVE provides a stress-free platform for collaborative learning. For instance, students can repeatedly practice their skills together in groups, which is impossible in real clinical settings. All these enable better and more comprehensive preparation of healthcare students for future clinical training.

### BRIEF DESCRIPTION OF THE DRAWINGS

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

FIGS. 1A-1C shows some photos of students learning in an example Hybrid CAVE Classroom.

FIG. 2 shows Main Components of the Fully Immersive Interactive Projection System.

FIGS. 3A-3B show 2D mode and 3D-mode Projection Warping Process respectively.

FIG. 4 shows 3D Model Drawing of the Projectors of the Immersive Projection System and Projection Frustum inside the Immersive Room.

FIG. 5 shows Motion Capture Cameras of the Motion Capture System Installed near the Ceiling area.

FIG. 6 shows Speakers of the Surround Sound System Integrated Into the Immersive Room's Drywall.

FIG. 7 shows Construction Concept of Room-Inside-A-Room of the Immersive Room.

FIGS. 8A-8B show a Concept Drawing of Projector Cover Structure of the Immersive Room.

FIG. 9 shows a Projector Cover of the Immersive Projection System with Images Projected onto it.

FIG. 10 shows an Image of Demonstrating Tilted Side Wall with Opening of the Immersive Room

FIG. 11 shows a Wall Painted in Grey-Tinted Surface Paint with Embedded Air Ventilation Panel Painted in the same Color.

FIGS. 12A-12B are Design Drawing of Supplementary Visual Aid System (left) with Hidden Control Panel and Projected Area (right) in the Immersive Room.

FIG. 13A shows the present invention used as a conventional class, while 13B shows the present invention being used as a class in a virtual environment.

FIGS. 14A-14C show the examples of Augmented Reality (AR), Virtual Reality (VR), and Mixed Reality (MR) respectively.

FIGS. 15A-15C show examples of practical learning by the present system respectively.

FIG. 16 shows Hybrid learning mode of the HiVE.

FIG. 17A (Left) and FIG. 17B (Right) represent the actual clinical setting and the immersive projection of 360-degree images captured at the same setting respectively.

FIG. 18 shows Incorporation of Mixed Reality (MR) into HiVE teaching.

FIG. 19 shows Tutorial classroom setting in the HiVE that can be conducted in the same teaching session.

### DETAILED DESCRIPTION OF THE EMBODIMENTS

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that the above descriptors are used merely for ease of referencing multiple elements or components.

### I. Virtual Environment Virtual Environment (HiVE)

HiVE (Hybrid Immersive Virtual Environment) is the world's first large-scale X-Reality hybrid classroom developed by the Hong Kong Polytechnic University. HiVE adopts fully immersive Cave Automatic Virtual Environment (CAVE) technology for practical and collaborative learning and develops it into a 6-sided CAVE platform. The 6-sided CAVE platform may create an immersive 2D or 3D environment to help students visualize abstract concepts and experience the limitless possibilities of the digital world. Additionally, this 6-sided CAVE platform provides a virtual training environment that enables students to experience and practice work-related skills in realistic scenarios such as fire outbreaks, medical procedures, and aircraft control rooms that are not easily accessible in the actual world. The Hybrid CAVE also allows teachers to seamlessly switch between face-to-face and immersive teaching, blending virtual technology with conventional learning to enhance students'learning experience.

The concept of XR hybrid classroom comprises, for example, how to combine a teaching classroom and a CAVE system into a hybrid teaching facility. The fully immersive CAVE technology comprises, for example, how to design and install the 6-sided projection VR projection in a classroom environment.

Most of the prior art CAVE has 4-side or 5-side walls only and hence fails to give a fully immersive experience. Besides, the conventional CAVE is limited to a standalone application which belongs to virtual technology applications only, so teachers find it difficult to switch between face-to-face and immersive teaching in a classroom environment when using a conventional CAVE.

The present HiVE is a full Immersive CAVE and can give a fully immersive experience to users. The HiVE may create a Hybrid CAVE Classroom and provide a X-Reality simulation, enable seamless transition of teaching modes, and enables users to interact with real or digital objects simultaneously in a CAVE environment; besides, the HiVE may create a multi-CAVE platform and can provide real-time interaction between the multi-CAVEs.

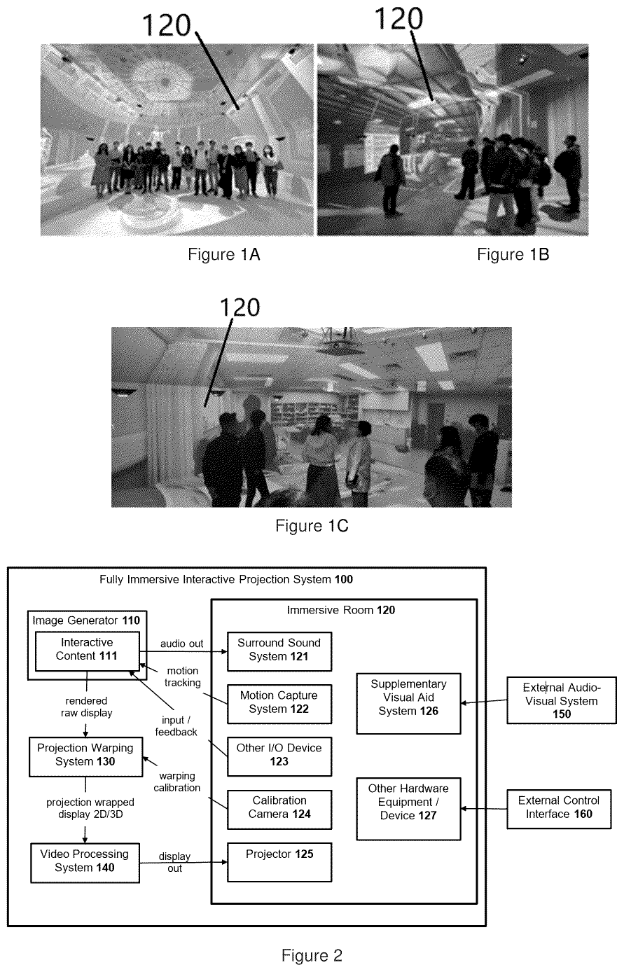

FIG. 1A shows some photos of students learning in an example Hybrid CAVE Classroom, i.e. the immersion room 120 of the present application. FIG. 1A shows students taking a group photo in the immersion room 120; FIG. 1B shows the ongoing class, wherein the students listen to the course and watch the 3D images of the course in the immersion room 120; and FIG. 1C shows the students interacting with a teacher during the course in the immersion room 120. Understanding theory-based conceptual subjects can be extremely challenging for many students. The present Hybrid CAVE Classroom is a 6-sided CAVE-based technology which creates an extremely real immersive environment to assist students in visualizing abstract concepts and novel points of view that are impossible to display in a real environment. Moreover, this technology allows students to engage in experiences that may not be easy for them to access in the real world, such as fire outbreaks, medical surgery and aircraft control room, etc. Theory-based intellectual courses can be very difficult for students to comprehend. With the help of the new 6-sided CAVE technology, students can visualize abstract concepts that are impossible to portray in the real world. Additionally, this technology enables students to experience and participate in realistic scenarios like fire outbreaks, medical procedures, and aircraft control rooms that are not easily accessible in the actual world.

Thus, the present HiVE is a Fully Immersive CAVE which is an extremely real immersive environment, and can assist students in visualizing abstract concepts and novel points of view that are impossible to display in a real environment.

### II. Design and System for Hive as a Fully Immersive Interactive Hybrid Classroom

The HiVE may be configured into a Fully Immersive Interactive Hybrid Classroom, which is one example of the inventive 6-sided CAVE platform.

The Fully Immersive Interactive Hybrid Classroom is a Fully Immersive Interactive Projection System. The Fully Immersive Interactive Projection System may comprise an Image Generator 110, a Projection Warping system 130, a video processing system 140 and an Immersive Room 120. An Immersive Projection System or projectors 125, a Motion Capture System 122, a Surround Sound System 121, a Supplementary Visual Aid System 126, etc., may be provided in the Immersive Room 120. The Fully Immersive Interactive Projection System may be connected to an external audio-visual system 150 to input or output audio-visual signals, and/or to an external control interface 160, so as to be controlled from outside by a person or a computer.

FIG. 2 shows the main components of the Fully Immersive Interactive Projection System 100 which comprises an Image Generator 110 for projecting a fully immersive interactive image. Details of each component of the system are elaborated in detail in the following sections.

The Image Generator 110 may be implemented by a computing workstation with at least a Central Processing Unit (CPU), a memory, a storage system, a set of Graphics Processing Unit (GPU), a power supply unit (PSU), and a set of I/O interfaces. The Image Generator may run on a compatible operating system (OS) to process input signals, execute commands written in applications saved to the storage system, and render display and sound output for the Fully Immersive Interactive Projection System.

A configurable launcher application with graphical user interface is available on the Image Generator to interface with connected hardware devices and to launch commands in raw or executable format. The Image Generator 110 can be configured to render content in either 2D or 3D mode. When set to render content in 2D mode 200, the launcher application sends a command to set the projectors 125 to operate in 2D mode and another command to the projection warping system 130 (may be used for blending also) to engage the 2D mode mapping profile; when set to render content in 3D mode 300, the launcher application sends a commend to set the projectors to operate in 3D mode and another command to the projection warping system 130 (for blending also) to engage the 3D mode mapping profile.

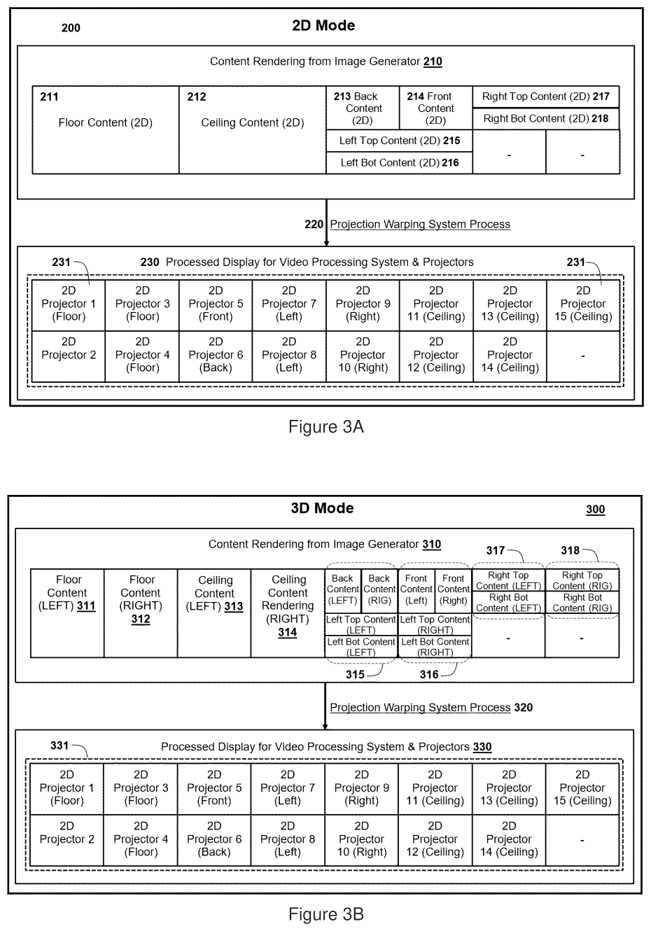

The projection warping system performs the process of projection warping and blending. FIGS. 3A-3B show 2D-mode and 3D-mode Projection Warping Process, respectively. During the process of projection warping 220 and blending, a two-step process is engaged to produce the desirable immersive visual effect. Firstly, the interactive content on the Image Generator is rendered and arranged based on the physical layout of the projection surface by content rending from the image generator, step 210. Here, the projection surface is defined as a continuous surface facing the same direction in the Immersive Room. Projection Warping system process 220 is then done based on the rendered display layout then further processed, rearranged, and distributed to each projector. When running 2D mode 200 with projection warping and blending, the entirety of pixel assigned to each projector will be displayed by the projector directly. When running in the 3D mode 200, the Image Generator will render images for both the left and the right eye, and arranged in side-by-side manner as final output to send to the video processor.

The interactive content executed on the Image Generator 110 may use the motion capture information provided by the Motion Capture System 122 as user input to update the interactive content. When the viewer fitted with motion tracker moves around in the Immersive Room 120, the interactive content can be rendered from the perspective of the viewer to offer a first person perspective rendering tailored to the viewer. Optionally, other input devices such as controllers and haptic devices can also be connected to the Image Generator 110 to use as extra I/O devices to add additional interactivity elements into the system 100.

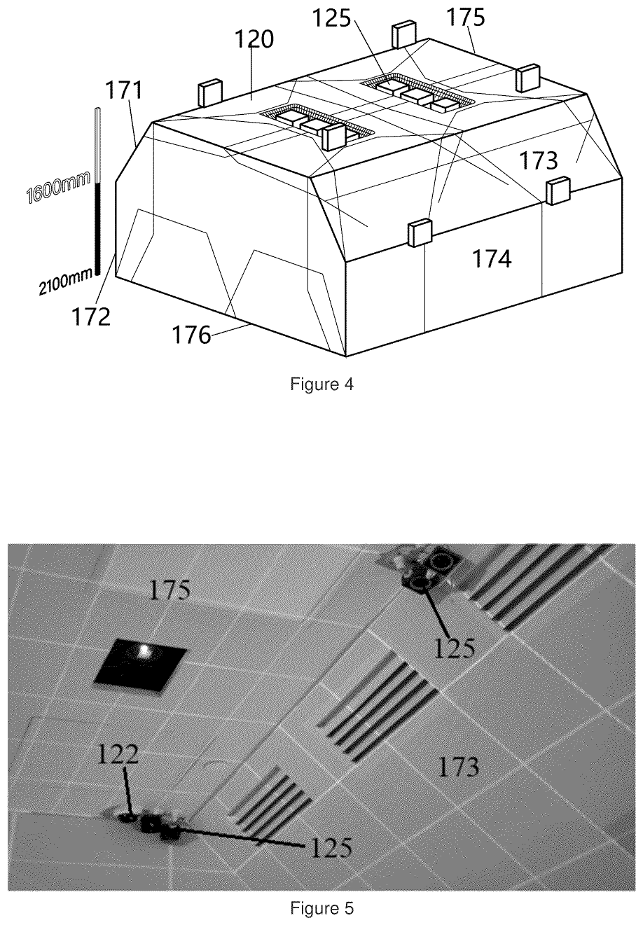

FIG. 4 shows a 3D Model Drawing of the Projectors 125 of Immersive Projection System 100 and Projection Frustum inside the Immersive Room 120 of the Immersive Projection System 100.

The immersive projection system 100 features a combination of Ultra Short Throw (UST) (i.e., projector throw ratio<0.5:1) and Short Throw (ST) (i.e., projector throw ratio between 0.5-1:1) projectors 125 which are arranged strategically outside the visible space of the system operating in a front projection manner. For the projectors supplying image projections for the front, back, left (171, 172), right (173, 174), and ceiling 175 of the Immersive Room 120 of the Immersive Projection system 100. UST projectors or projectors equipped with UST lens are used to minimize the throw distance needed between the projectors and the projection surface, and to maximize the effective space the viewer can move inside the system without encountering the projector's projection frustum and cast a shadow. For the projectors supplying image projections for the floor 176, ST projectors or projectors equipped with ST lens are used. There is at least 1 projector for each projection side (front, back, left, right, ceiling, floor). When more than 1 projector is used for any given side of the system, the projection image output from each of the projector should have some overlap region so that an effective projection warping and blending can be achieved to seamlessly merge the projection image of these projectors.

Projectors 125 for walls (i.e., front, back, left, and right projectors) are installed inside the space on the ceiling area, a set of custom-made projector cover structure 500 is installed around the projector and lens body to conceal the projectors 125 while allowing light from the ceiling projectors to project onto them. Projectors for the ceiling are installed behind the left and right walls outside of the space, an opening matching the shape of the projection's projection frustum is carved out on the wall for each projector to allow light to pass through while minimizing the impact to immersion. Projectors for the floor are installed on top of the ceiling wall and projected onto the floor through opening on the ceiling carved out in the same manner as the ceiling projectors.

The projectors 125 are plugged in to a video processing system 140 that is interfacing with the Image Generator 110 through a layer of projection warping system 130 to produce frame-synchronized image signal to the projectors. The projectors are capable of operating in either a normal 2D mode or a 3D stereoscopic mode. When operating under the 2D mode 200, users are able to see clear image with their naked eyes. When operating under the 3D mode 300, the projectors display images intended for the either the left or right eye in an alternating manner, users need to wear a pair of active stereo 3D glasses that is synchronized with the projectors'display frequency to separate the alternating images in order to see a clear stereoscopic image. During 3D mode, a 3D synchronization signal is needed to synchronize the active stereo 3D glasses with the display image from the projectors. Such 3D synchronization signal can either be generated by the video processing system when the 3D image is processed and created by the video processing system, or from any one of the projectors connected to the video processing system, when the 3D image is processed and created by the projectors themselves.

A plurality of calibration cameras 124 with fisheye lens are placed strategically inside the system and connected to the Image Generator for projection warping and blending. To facilitate projection warping and blending, a camera-based calibration process conducted by the projection warping and blending system is needed, which computes an UV mapping transformation of the real-world image captured by the calibration cameras with a pre-defined 3D model of the room. Projection warping and blending can then be achieved by applying the computed UV mapping onto the rendering buffer of the Image Generator's GPU. The UV mappings for both of the 2D and 3D modes are computed and the user can switch between 2D and 3D projection warping and blending by sending the corresponding command on the Image Generator.

FIG. 5 shows Motion Capture Cameras of the Motion Capture System 122 Installed near the ceiling 175 of the immersive room 120.

To add interactivity to the system, a plurality of motion capture/sensing devices using optical or infrared light mechanism are installed at strategic locations inside the system near the ceiling 175 of the immersive room 120, as examples of the Motion Capture System 122. User/object fitted with retroreflective markers forming pre-defined shape, or battery-powered trackers with pre-registered hardware identification number, can be identified by the installed motion capture/sensing devices, allowing the motion capture system to resolve the position/movement of the tracked body (motion capture information). The motion capture information is streamed out using network or relevant common protocol for use by the fully immersive interactive projection system as input data to render interactive contents on the display system.

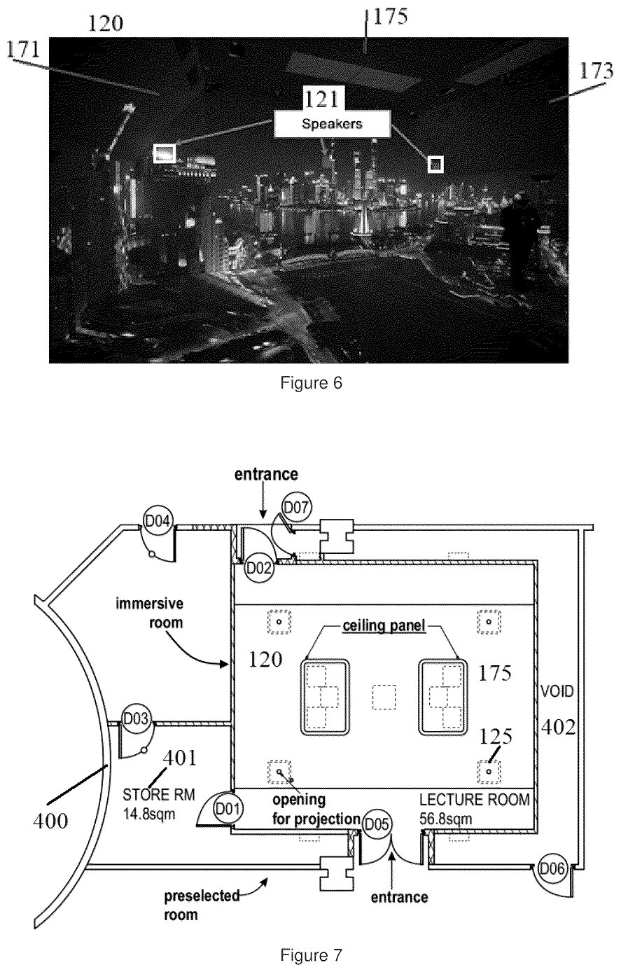

FIG. 6 shows Speakers of the surround sound system 121 integrated into the drywall of the immersive room 120.

A surround sound system 121 is installed outside of the display area to provide immersive spatial sound inside the system 100. The surround sound system 121, consisting a minimum of one subwoofer and a set of speakers for the front, left, right, and back of the system, are placed in strategic locations around the system to enhance the produced surround sound effect.

The walls which the projected image will be displayed on are carved rectangular openings just large enough to fit the speakers of the surround sound system, such that the sound produced by the speakers can be projected to the inside of the immersion room 120. The openings on the wall are covered with perforated panel painted the same color as the wall to minimize its impact to the system's immersion while allowing adequate sound to pass through.

FIG. 7 shows a construction concept of “Room-Inside-a-Room” design of the immersive room 120, and is a top view of the design of the immersive room 120. The sizes marked on FIG. 7 are designed for an example immersion room and can be varied upon actual requirements and actual applications when the present invention is implemented.

The immersive room 120 is created inside the original structural room 400, for example by using drywalls. This partitions the original structural room into an immersive room 120 for the Fully Immersive Interactive Projection System 100 and additional room(s) 401 or space(s) for storage (e.g. hosting the Image Generator), concealment of relevant hardware equipment/device, or for any other purposes, and/or leaving void 402.

The projections 125, as described in the Immersive Projection System section, are installed behind the drywall, under or on the ceiling 175 and on the floor, or installed inside the Immersive Room around the ceiling area concealed behind custom-made covers (front, back, left, and right wall projectors).

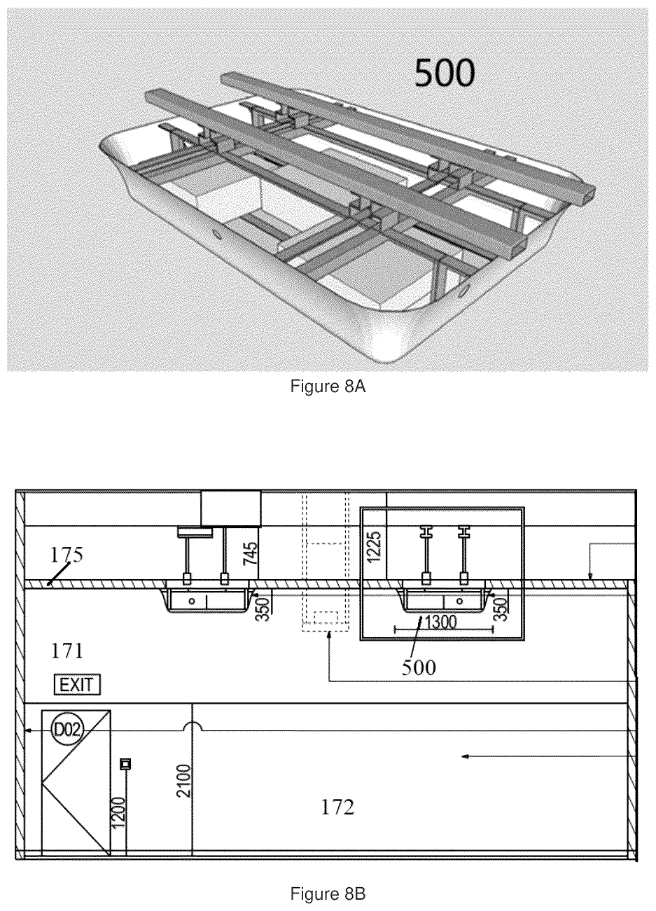

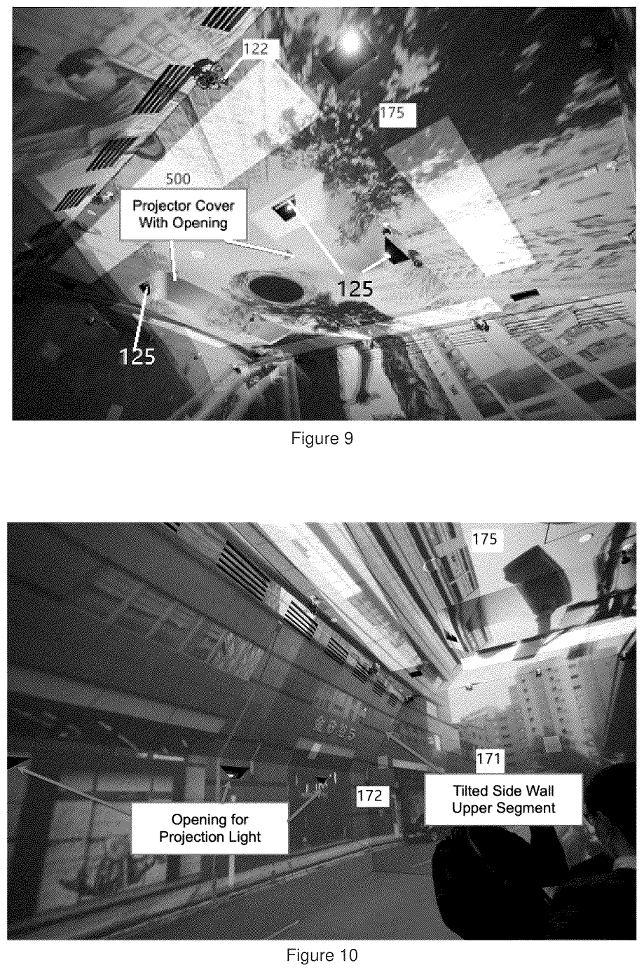

FIG. 8A shows a concept drawing of the Projector Cover Structure 500 of the Immersive Room 120, FIG. 8B shows a construction concept of the Projector Cover Structure 500 installed on the ceiling 175 of the immersion room, and FIG. 9 shows the Projector Cover 500 of the Immersive Projection System 100 with Images Projected 125 onto it. The custom-made projector cover structure is made of rigid material (such as fiber glass) and has curvy edges to minimize blocking the projection light from ceiling projectors. Openings are made on the projector cover to allow projection light to pass through.

FIG. 10 shows an Image of Demonstrating Tilted Side Wall with Opening of the Immersive Room 120.

The side walls (i.e., the drywalls on the left and right side of the Immersive Room) consist of two segments-the vertical lower segment 172 and the internally tilted upper segment 171. Ceiling projectors are placed behind the wall at a height above normal height of a person and oriented to project towards the ceiling. For each projector, an opening with the shape of the projector's projection frustum is cut on the lower segment 172 of the drywall to allow the projection light to pass through. With a fair distance above the cut opening, the upper segment 171 of the drywall is tilted inward at an angle that closely matches the light path of the bottom of the projector's projection frustum as shown in FIG. 4.

Entrances to the Immersive Room are equipped with concealed doors where the surface material of the concealed door facing the interior of the system matches the material used at the inside of the immersion room 120 and painted with the same surface paint.

The interior of the immersion room 120 is painted with a grey-tinted surface paint specially chosen to minimize the internal reflection of the projector lights while preserving the vividness of the projected color.

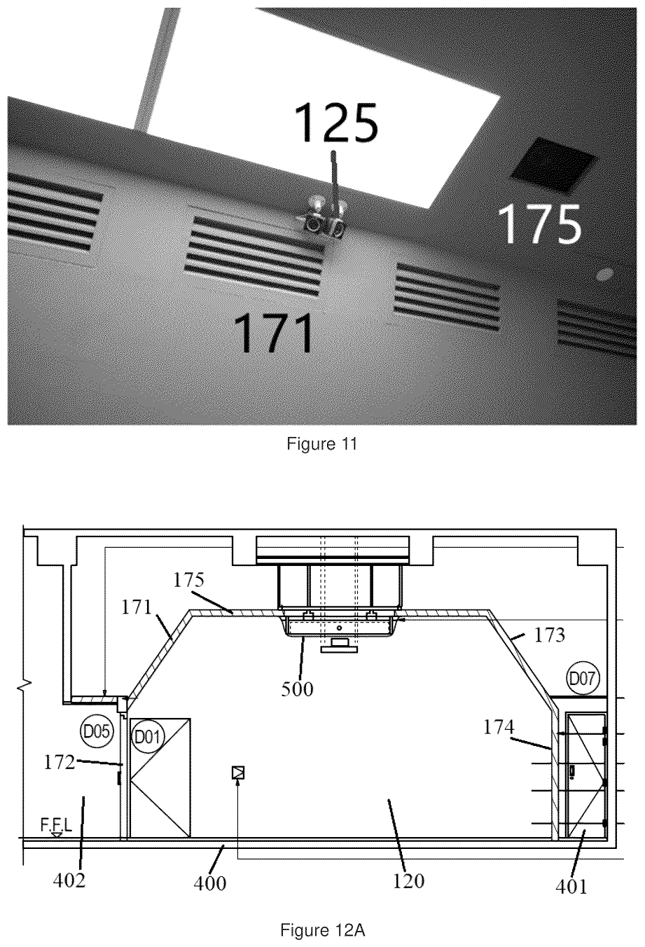

FIG. 11 shows a wall of the Immersive Room 120 painted in grey which is the tinted surface of the immersive room provided with embedded air ventilation panel (that is painted in the same color) in the upper segment 171, wherein a set of projectors 125 is installed under the ceiling 175 of the immersion room.

Other equipment or devices that are necessary to support the normal usage of the system or relevant regulatory requirements are installed behind the drywall, embedded into the drywall in similar manner as speakers of the surround sound system 121, or placed inside the Immersive Room 120 at positions least distractive to the viewers. Examples of such equipment/device include but not limited to: air ventilation system, light panel, carbon dioxide detect, sprinkler, etc. Without sacrificing the functionality of the equipment/device, the appearance of the devices can be set to match the painted color of the Immersive Room.

FIGS. 12A-12B are the design drawings of supplementary visual aid system (left) with hidden control panel and projected area (right) in the immersive room 120, and show the construction concepts of the vertical sectional views of the immersion room 120 inside the original structural room 400.

An additional 2D projector fitted on a motorized ceiling projector lift is concealed behind the projector cover 500 under the drywall ceiling 175, with the bottom of the motorized ceiling projector lift forming part of the ceiling drywall structure in the immersion room 120. Activated by pressing the button on the control panel behind a hidden cabinet door inside the system. External audio-visual devices can be connected to this supplementary visual aid system to provide additional audio-visual content rendered in 2D for viewers.

As described above, the important features of the present Fully Immersive Interactive Hybrid Classroom may comprise, for example:
(1) It is an all-front-projection fully immersive projection system.
(2) The approach may build an immersive room inside a large room to conceal the related hardware system, and lower the cost to build.
(3) The shape of the room comprises 6-sides and tilted upper segment of side walls, allows more concurrent viewers, and has more space inside for placement of equipment to create mixed reality environment.
(4) It is a Room-Inside-A-Room design.
(5) It can perform projection warping and display screen transformation.
(6) It may fulfill air ventilation and regulatory restrictions of a fully immersive space, and has better air ventilation to support prolonged use session.
(7) Projection warping of highly complex system construction thereof uses side-by-side passive stereo.
(8) It achieves higher system footprint to usable immersive space ratio (lower space needed), and is higher scalability,

The applications of the present invention may comprise hybrid mode classroom learning with mixed reality elements, multi-user simulation training, and classrooms in academic institutions, especially for clinical education and training.

### III. System of Hybrid Interactive Virtual Environment for Clinical Education and Training Adopting a Fully Immersive CAVE

Hybrid Interactive Virtual Environment (HiVE) is a large-scale XR hybrid classroom with fully immersive CAVE technology allowing tailor-made clinical simulation, clinical skills execution, collaborative education (student number between 20 and 40), human-to-equipment and human-to-human interaction for collaborative learning in clinical education and training.

The present system of Hybrid Interactive Virtual Environment for Clinical Education and Training adopts A Fully Immersive CAVE, can take a 360-degree photograph and calibrate the imaging equipment for media projection on the HiVE. The system integrates virtual and physical objects to facilitate realistic simulation and can select available software to facilitate scenario design for simulation. The immersive room of the system is a Fully immersive 6-sided CAVE platform and is capable to display 360-degree images obtained in different clinical settings, can be configured into a XR (Extended reality)-enabled hybrid classroom. The system enables discipline-specific installation of a large-scale CAVE, and can save high logistical and administrative cost in conducting face-to-face and immersive teaching in multiple physical locations, including on-campus and out-of-campus (e.g. hospitals).

The present system of Hybrid Interactive Virtual Environment for Clinical Education and Training is an innovative experiential learning environment. To effectively translate knowledge into clinical practice, students must gain a thorough understanding through practical application. The system utilizes the Cave Automatic Virtual Environment (CAVE) technology to provide students with a highly immersive and realistic environment that replicates actual clinical sites, incorporating real equipment and spatial representation. By using this innovative technology, students can practice skills and better prepare for clinical training in hospitals. This technology provides a safe and “fault-tolerant” atmosphere for students to engage in different scenarios, such as routine and emergency situations. The CAVE technology not only creates a realistic clinical environment but also promotes peer learning by enabling up to 30-40 students to interact with each other and the virtual environment. Most importantly, the vivid visualizations and interactive elements in the CAVE provides a stress-free platform for collaborative learning. For instance, students can repeatedly practice their skills together in groups, which is impossible in real clinical settings. All these enable better and more comprehensive preparation of healthcare students for future clinical training.

The present system of Hybrid Interactive Virtual Environment for Clinical Education and Training comprises a hybrid classroom. Space is a valuable resource in universities. Combining a teaching classroom and a CAVE system into a hybrid teaching facility can save installation space. More importantly, this hybrid classroom allows teachers to conduct and switch between face-to-face and immersive teaching easily in a classroom environment to blend virtual technology with traditional learning. This hybrid teaching facility enables teachers to perform a seamless transition of delivery mode between face-to-face lectures and immersive experiences, achieving the goal of blending virtual technology with conventional learning.

Clinical education often demands space to accommodate various equipment and large-class teaching and skill demonstrations. However, space is a valuable resource in universities. A single multi-purpose room that enables both traditional lecturing and hands-on practicum would save significant space. Moreover, this room allows instant switching among different teaching modes to meet different learning objectives in a teaching session.

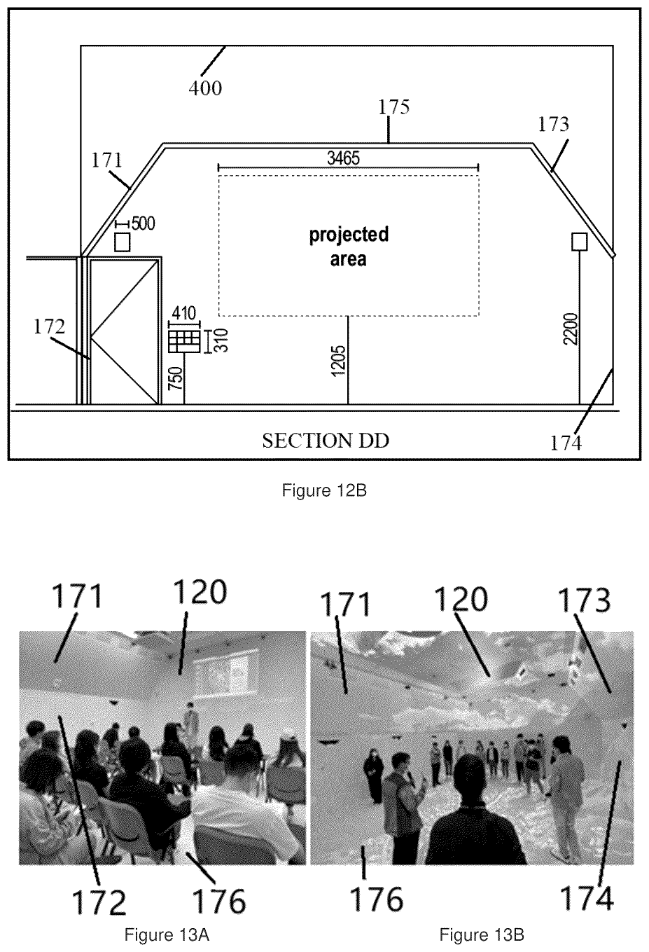

For example, FIG. 13A shows that the immersive room 120 of the present invention is used as a conventional class, in which the students sit on the chairs placed in rows and listen to the course taught by a teacher with a projected screen. FIG. 13B shows that the immersive room 120 of the present invention is used as a class in a virtual environment, wherein the student and the teacher stand within the virtual environment produced by means of the present invented system showing a stereo 3D image comprising the clouds in sky and the buildings on the earth. In FIGS. 13A and 13B, the vertical lower segments 172, 174 and the internally tilted upper segments 171, 173 are arranged in the left and right sides of the immersions room respectively. In FIG. 13B, the stereo 3D image is created by the image generator 110 of the present invention, which can be configured to process input contents and render the input contents in either 2D mode or 3D mode to generate interactive contents for clinical education and training. The projection warping system as shown in FIGS. 2, 3A and 3B performs a process of projection warping and blending to generate a projection warped display image. The video processing system 140 processes the projection warped display image to generate a frame-synchronized display output. The immersive room 120 comprises a surround sound system 121 to produce audio output to the interactive contents, a motion capture system 122 to produce tracking information of the users inside the immersive room and send the tracking information to the interactive contents, and projectors 125 to project the frame-synchronized display output from the video processing system 140 to generate a 3D interactive image within the immersive room for clinical education and training, such that users in the immersive room may watch and listen to the 3D image and interact with the 3D image and/or with each other for clinical education and training.

The present system of Hybrid Interactive Virtual Environment for Clinical Education and Training utilizes extended reality which enables advanced visualization. Visualizing the concepts of human anatomy, physiology, and pathology is essential in clinical education, as it facilitates the translation of theoretical knowledge into clinical applications, bridging the gap between theory and practice. The 6-sided CAVE technology suite enables extended Reality (XR) presentation, incorporating augmented (AR), virtual (VR) and mixed (MR) reality to offer richer visualization detail. For instance, students can interact with MR-based human models to consolidate their spatial understanding of anatomical structures and pathologies. Students can also operate actual equipment to practice their skills, all in the same suite.

XR refers to the family including AR, VR, and MR. VR can only allow users to visualize and interact with a digital object in a virtual environment without feeling touch or interaction with a real object. To enhance sensation and interaction, the present system 100 of Hybrid Interactive Virtual Environment for Clinical Education and Training successfully provides CAVE with MR applications using HoloLens (not shown) in a CAVE environment. The articulated hand-tracking input of the MR device enables users to interact with real or digital objects simultaneously in an immersive environment.

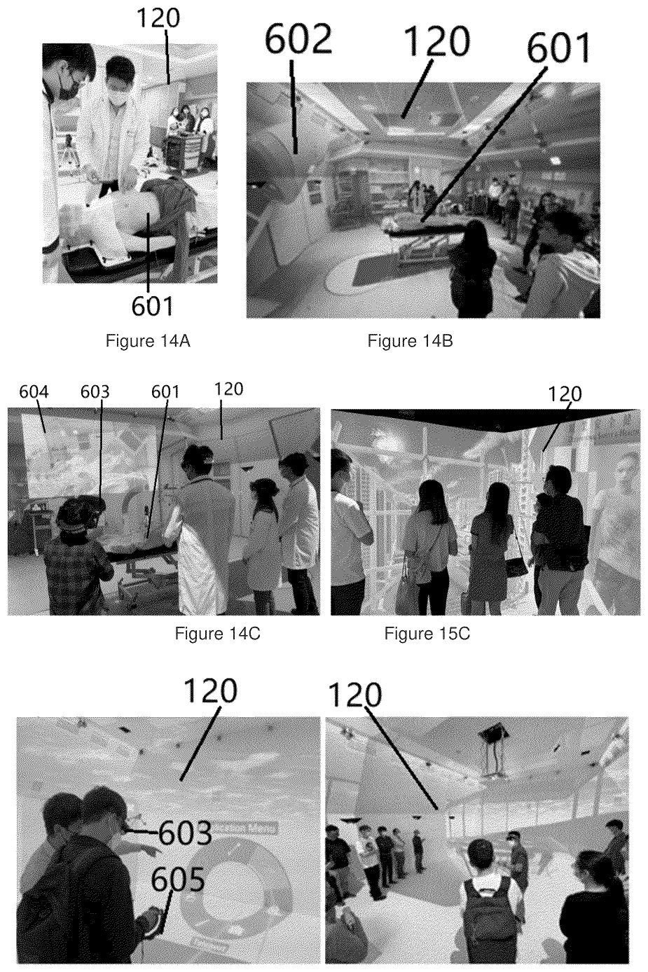

FIGS. 14A-14C show the examples of AR, VR, and MR, respectively. In the AR example shown in FIG. 14A, a virtual patient 601 lies down on a virtual medical bed in the immersion room 120, a 3D image is projected to show the patient and to show a partial anatomy of his body if desired, and students watch the patient and his body and listing to a teacher teaching the course. In the VR example in the immersion room 120 shown in FIG. 14B, the 3D image thereof shows a virtual patient 601 being treated by a medical instrument 602 (such as a linear accelerator), while the students stand around the 3D image listening to the course by the teacher, wherein the students and the teacher may interact with a digital object in a virtual environment without feeling touch or interaction with a real object. In the MR example shown in FIG. 14C, the students and the teacher stand within (i.e. immersed in) the 3D image in the immersion room 120, listening to the course and wearing goggles 603 to watch the 3D image interacting with the image and/or with each other.

Thus, the Hybrid CAVE classroom of the present invention achieves the goal of blending virtual technology with conventional learning, facilitates the hands-on practical learning purposes, and provides a virtual environment for collaborative learning. This enables students from different parts of the world to give presentations and even interact with one another.

The hybrid interactive virtual environment present system 100 for clinical education and training of the present invention facilitates practical learning and collaborative learning. “Knowledge is of no value unless you put it into practice.” VR can create an interactive, hands-on experience in a simulated environment. FIGS. 15A-15C show examples of practical learning by the present system respectively. In FIG. 15A, a student wears a goggle 603 and takes a handset 605 (such as a game controller) in the immersion room 120, the image shows the virtual buttons corresponding the real buttons on the handset 605, and a teacher is teaching the student to use the handset to interact with the 3D image. In FIG. 15B, a plurality of students stand around a teacher and listen to the teacher teaching a course in the immersion room 120, they each wears a goggle 603 respectively. In FIG. 15C, some students stand within a 3D image listening to a course and watching the 3D image of a street view for example.

This safe, risk-free, and practical setting helps students develop professional skills through learning by doing. The VR hybrid classroom of the present invention supports real-time multi-CAVE collaboration among CAVE systems also. This enables students from different parts of the world to give presentations and even interact with one another.

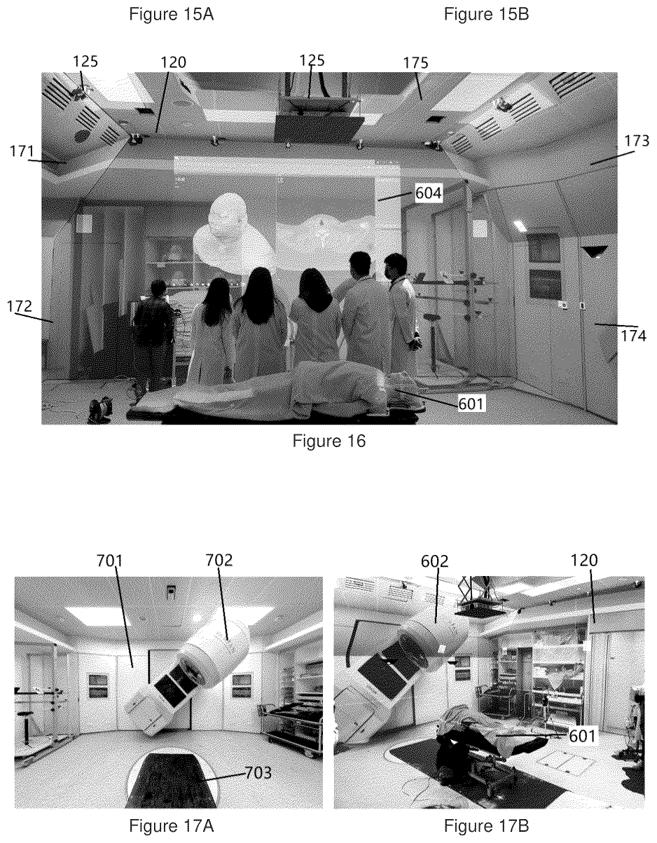

Moreover, FIG. 16 shows a hybrid learning mode of the HiVE system 100 of the present invention for clinical education and learning. Projection on a screen 604 (or a wall) is a set of computed tomography (CT) images and 3D volume rendering of a cancer patient 601, who is represented by the mannikin lying on the couch in the simulated treatment room with appropriate accessories applied. The software displayed CT images of the patient, allowing students to visualize the relevant 3D anatomy via VR. The students stand within the 3D image listening to the course and watching the 3D image. In this embodiment, both 2D mode and 3D mode images are projected by the present system. In FIG. 16, the vertical lower segments 172, 174 and the internally tilted upper segments 171, 173 are arranged in the left and right sides of the immersions room 120 respectively, and a plurality of projectors 125 are arranged under or on the ceiling 175 of the immersions room 120.

FIG. 17A represents an actual clinical setting, while FIG. 17B represents an immersive projection of 360-degree images captured at the same clinical setting projected by the present system. In FIG. 17A, the room 701 has a linear accelerator 702 and a carpet 703. In FIG. 17B, when the 360-degree or 3D image is projected by the present system 100, the virtual linear accelerator 602 and the carpet are displayed in the immersion room 120 and are almost same as those of FIG. 17A, to imitate the arrangement of the actual clinical setting of FIG. 17A; besides, in FIG. 17B, a virtual patient 601 lying on a bed is shown in the immersion room 120 for clinical education and training.

The immersion room 120 FIG. 17B is construed according to the concept of the present invention, and may adopt the “Room-Inside-A-Room” design as shown in FIG. 7, to form a Hybrid Interactive Virtual Environment (HiVE) system 100 of the present invention. The HiVE system is configured for clinical education and training, and comprises: an immersive room 120 configured to a fully immersive interactive hybrid classroom, the immersive room being a 6-sided Cave Automatic Virtual Environment (CAVE) platform; an image generator 110 configured to process input content and render the input contents in either two-dimensional (2D) mode or three-dimensional (3D) mode to generate interactive contents for clinical education and training; a projection warping system 130 configured to perform a process of projection warping and blending to generate a projection warped display image; and a video processing system 140 for processing the projection warped display image to generate a frame-synchronized display output; wherein the immersive room comprises a surround sound system 121 for producing an audio output to the interactive contents, a motion capture system 122 for producing tracking information of a user inside the immersive room and sending the tracking information to the interactive contents, and plural projectors 125 for projecting the frame-synchronized display output from the video processing system to generate a 3D interactive image within the immersive room for clinical education and training, such that the user in the immersive room are enabled to watch and listen to the 3D interactive image and interact with the 3D interactive image and/or with each other for clinical education and training.

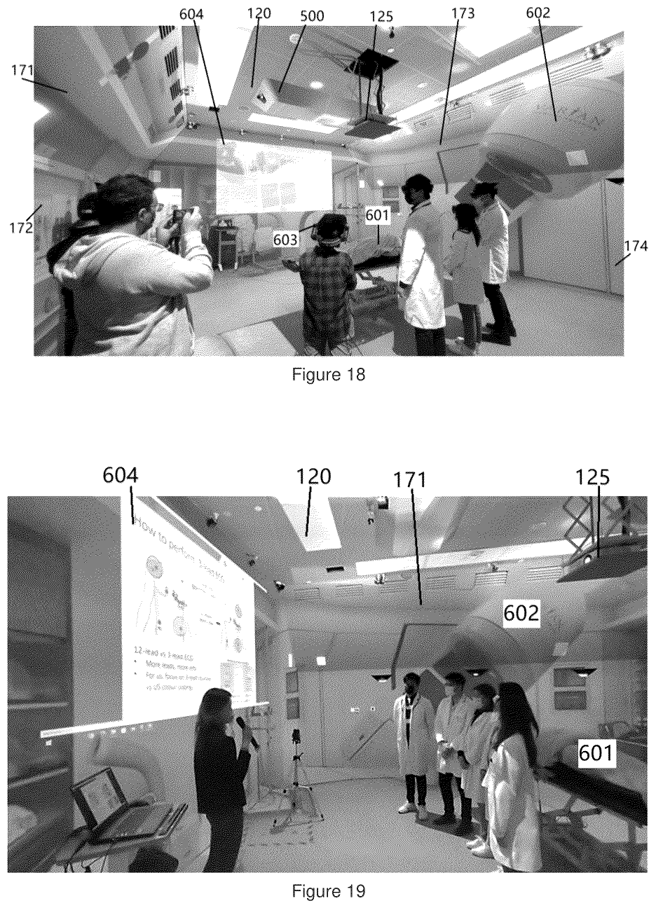

FIG. 18 shows Incorporation of MR into HiVE teaching based on the virtual 3D image as shown in FIG. 17B. The immersion room 120 and the 3D image of FIG. 18 are same as those of FIG. 17B, and further comprise a screen 604 showing the contents of the course in 2D mode. Some students stand within the 3D image and wear goggles 603 respectively, watching the 3D image and listening to the course for clinical education and training. In FIG. 18, the vertical lower segments 172, 174 and the internally tilted upper segments 171, 173 are arranged in the left and right sides of the immersions room 120 respectively, and a plurality of projectors are arranged under or on the ceiling 175 of the immersions room 120, including a projector 125 to show the 2D image on the screen 604.

FIG. 19 shows a tutorial classroom setting in the immersions room 120 of the HiVE system 100 of the present invention that can be conducted in the same teaching session. The immersion room 120 and the 3D image of FIG. 19 are same as those of FIG. 17B, but viewed in different direction, such as in a perpendicular direction of view from that of FIG. 17B, as shown by the virtual linear accelerator 602 and the virtual patient 601. The immersion room 120 shown in FIG. 19 further comprises a screen 604 showing the contents of the course. A teacher stands near the screen and teaches the course to the students stand within the 3D image. FIGS. 18 and 19 show different side views of the 3D image of FIG. 17B.

Based on FIGS. 17-19, the present invention also provides a method for creating Hybrid Interactive Virtual Environment (HiVE) for Clinical Education and Training, comprising: forming an immersive room by a 6-sided Cave Automatic Virtual Environment (CAVE) platform so as to configure it into a fully immersive interactive hybrid classroom, inputting or saving contents for clinical education and training into an image generator positioned in the immersive room, wherein the image generator is configured to process the input or saved contents and render the contents in either 2D mode or 3D mode to generate interactive contents, performing a process of projection warping and blending by a projection warping system, to generate a projection warped display image, and processing the projection warped display image by a video processing system to generate a frame-synchronized display output, wherein the immersive room comprises a surround sound system to produce audio output to the interactive contents, a motion capture system to produce tracking information of the users inside the immersive room and send the tracking information to the interactive contents, and projectors to project the frame-synchronized display output from the video processing system to generate a 3D interactive image within the immersive room for clinical education and training, such that users in the immersive room may watch and listen to the 3D image and interact with the 3D image and/or with each other for clinical education and training.

As described above, the present system of Hybrid Interactive Virtual Environment for Clinical Education and Training adopts A Fully Immersive CAVE, and can take a 360-degree photograph and calibrate the imaging equipment for media projection on the HiVE. The system integrates virtual and physical objects to facilitate realistic simulation and can select available software to facilitate scenario design for simulation. The system is a fully immersive 6-sided CAVE and is capable to display 360-degree images obtained in different clinical settings, can be configured into a XR-enabled hybrid classroom. The system enables discipline-specific installation of a large-scale CAVE, and can save high logistical and administrative cost in conducting face-to-face and immersive teaching in multiple physical locations, including on-campus and out-of-campus (e.g. hospitals).

The present system of Hybrid Interactive Virtual Environment for Clinical Education and Training may achieve advantages. For example, it can provide pre-clinical training with immersive experience to the medical students. It can provide an immersive virtual tour of hospital settings, since onsite tour is usually restricted, so it can be an essential element in bridging theory and practice in healthcare education, allowing interaction among learners and teachers. Thus, it is more convenient and reduces technological barriers compared to headset-based learning methods, can promote human-to-human interaction and dynamic teamwork training, narrows the theory-practice gap in healthcare education with immersive scenario simulation for students to repeatedly practice a wide array of clinical skills.

The background setting of HiVE involves manually scaling 3D images and videos to improve the realistic visualization of the designated clinical area. This is essential for combining virtual and actual objects to enable practical training, such as connecting an oxygen source displayed on a 3D image to actual tubing during clinical simulation.

Various software applications are incorporated to bridge the theory-practice gap in healthcare education (see FIG. 15), including the projection of virtual anatomical structures or medical images (theory) onto human manikins (AR) during skills training (practice). This allows real-time evaluation of competency, enhances knowledge acquisition, and improves performance. The present invention may provide fully immersive clinical simulation for a wide spectrum of clinical education and training, interactive VR and XR models for practical training involving human-to-equipment and human-to-human interaction, and is live streaming of immersive videos for collaborative learning, facilitating mass teaching to increase student's exposure to a wider variety of clinical practice.

### IV. Implementation Example in Paediatric Cancer Care by the Hybrid Interactive Virtual Environment (HiVE) System and the Method of Use Thereof of the Present Invention

In addition to a medical course for teaching medical students in the immersion room 120 as described above in FIGS. 16-19, the HiVE system 100 and the method of use thereof of the present invention may be used to a patient for care and/or rehearsal, for example, for paediatric cancer care, called the HEROCARE (Holistic Education in Radiation Oncology and Care Empowerment for Cancer Children and Carers) Project, and overview of its Support Strategies is described below. The HEROCARE Project provides clinical education and training for patients, carers, health, and medical students at the same time.

As an example of the HEROCARE Project, a child patient having Paediatric Cancer may lay on an actual bed in immersion room 120, replacing the virtual patient 601 and virtual bed in FIGS. 16, 17B and 18-19. The virtual linear accelerator 602 may be replaced by another virtual medical instrument for treatment to the patient. The HiVE system 100 may project a 3D image simulating the treatment process to the child patient to rehearsal the actual treatment he/she will undergo, to get familiar with the treatment process and relieve his/her pressure.

As introduced in the “Technical Background” portion of the present description, challenges in current paediatric radiotherapy service may comprise, for example: after accidents, cancer is the second leading cause of death in children. Paediatric cancer patients require specialised treatment protocols distinct from those used in adult cancers. The psychological burden of cancer diagnosis and treatment on children and their families is profound. Anxiety and depression are common, complicating recovery and quality of life. In addition, the radiation therapy challenges are: for children undergoing radiation therapy, the requirement for complete immobilisation during multi-fractionated treatments often necessitates the use of multiple general anaesthesia (GA) or sedations, increasing the risk of anesthesia-related complications and adding to the emotional and physical burden on young patients.

According to the Hybrid Interactive Virtual Environment (HiVE) system and the method of use thereof of the present invention, HEROCARE's innovative approach may be used to improve patient and carer well-being, reduce treatment times, and advocate for new service models.

The HiVE system and method of use thereof of the present invention may provide Personalised Preparatory Services, introduces comprehensive and tailored preparatory sessions for children and their carers, utilising immersive technologies and simulations to reduce anxiety and reliance on GA/sedation.

The HiVE system and method of use thereof of the present invention may provide Treatment Efficiency, dramatically decreases treatment times through efficient preparatory work, eliminating the need for GA/sedation, thereby reducing hospital stays and improving the throughput of radiotherapy departments.

The HiVE system and method of use thereof of the present invention may provide Advocacy for Service Model Innovation, actively promotes the adoption of the HEROCARE's model as a standard practice in paediatric oncology, highlighting its benefits in patient care, cost reduction, and treatment efficacy to healthcare authorities.

The HiVE system and method of use thereof of the present invention may provide Holistic Support Network, establishes a cross-disciplinary collaboration among healthcare professionals, academics, and support staff to provide a holistic care environment, addressing not just the medical but also the psychological needs of patients and carers.

The HiVE system and method of use thereof of the present invention may provide a novel use of treatment preparations and rehearsals to minimise need of GA or sedation.

The HiVE system and method of use thereof of the present invention may provide Immersive Preparatory Workshops, utilises mixed reality and realistic simulations in preparatory workshops to familiarise children with the treatment environment, reducing the need for GA/sedation by alleviating fear and anxiety.

The HiVE system and method of use thereof of the present invention may provide Tailored Treatment Rehearsals, offers personalised treatment rehearsals that mimic actual radiotherapy sessions, allowing children to practice stillness and compliance without the risks associated with GA.

The HiVE system and method of use thereof of the present invention may provide Empowerment Through Education, engages children and their carers in educational sessions about the treatment process, empowering them with knowledge and confidence to undergo treatment with minimal or no GA.

The HiVE system and method of use thereof of the present invention may provide Multidisciplinary Team Collaboration. Brings together healthcare professionals from various fields, including oncology, radiography, psychology, and child life specialists, to provide a comprehensive and integrated approach to care, ensuring that all aspects of a child's well-being are addressed during treatment.

The HiVE system and method of use thereof of the present invention may provide Economic and Efficiency Benefits, achieves significant time and cost savings by reducing the reliance on GA, leading to shorter treatment durations, decreased hospital resource usage, and enhanced patient and carer satisfaction, while fostering cross-disciplinary collaboration enhances care efficiency and innovation.

Thus, according to the present invention, the objectives of the HEROCARE Project by the Hybrid Interactive Virtual Environment (HiVE) system and the method of use thereof of the present invention comprise:

Improve Patient and carer Well-being: Enhance the overall well-being of paediatric cancer patients and their carers by offering a comprehensive and personalised preparatory experience that minimises the reliance on general anaesthesia (GA), thereby mitigating its adverse physical and emotional effects.

Reduce Treatment Times and Costs: Achieve substantial time and cost savings for healthcare facilities by eliminating the need for GA/sedation in paediatric radiotherapy treatments, which, in turn, significantly reduces treatment time and leads to more efficient use of healthcare resources.

Advocate for New Service Models: Promote the innovative HEROCARE service model to healthcare authorities and institutions. Gain support from the medical community and stakeholders by demonstrating the model's effectiveness in improving patient care and treatment efficiency.

Fill the Preparatory Service Gap: Address the critical lack of preparatory services for paediatric radiotherapy patients, which often necessitates the use of daily GA/sedation, causing both physical and emotional trauma for children and their carers.

The HEROCARE project utilizes the Hong Kong Polytechnic University's (PolyU) exclusive capability as the sole provider of undergraduate radiography education in Hong Kong, and its history of successful pilot projects to lead and scale up innovative radiotherapy services. Thus, it Leverages PolyU's Unique Position.

Foster Cross-Disciplinary Collaboration: Develop a collaborative model that brings together multidisciplinary teams from healthcare, academia, and community organisations. This model aims to deliver a holistic care approach that addresses the varied needs of paediatric cancer patients and their families.

Ensure Long-Term Sustainability: Secure the project's future through robust support mechanisms, including dedicated funds and partnerships with healthcare providers and educational institutions. This ensures that the innovations introduced by the HEROCARE continue to benefit patients and the medical community in the long term.

Enable Expansion of Beneficiaries: the project's service model utilizing HiVE and immersive installations can be augmented to a broader group of healthcare targets, including adults and geriatric cohort requiring customized psychosocial and educational support as in the current model framework.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

In aspects, description is made with reference to the figures. However, certain aspects may be practiced without one or more of these specific details, or in combination with other known methods and configurations. In the description, numerous specific details are set forth, such as specific configurations, dimensions, and processes, in order to provide a thorough understanding of the implementations. In other instances, well-known processes and manufacturing techniques have not been described in particular detain in order to not unnecessarily obscure the description. Reference throughout this specification to “one embodiment,” “an embodiment,” “an aspect,” “one aspect,” “one implementation, “an implementation,” or the like, means that a particular feature, structure, configuration, or characteristic described is included in at least one embodiment, aspect, or implementation. Thus, the appearance of the phrase “one embodiment,” “an embodiment,” “one aspect,” “an aspect,” “one implementation, “an implementation,” or the like, in various placed throughout this specification are not necessarily referring to the same embodiment, aspect, or implementation. Furthermore, the particular features, structures, configurations, or characteristics may be combined in any suitable manner in one or more implementations.

While this specification contains many specifics, these should not be construed as limitations on the scope of what is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few examples, embodiments, aspects, and implementations are disclosed. Variations, modifications and enhancements to the described examples and implementations and other implementations may be made based on what is disclosed.

What is claimed is:

1. A Hybrid Interactive Virtual Environment (HiVE) system (100), the HiVE system is configured for clinical education and training, and the HiVE system comprising:
an immersive room (120) configured to a fully immersive interactive hybrid classroom, the immersive room being a 6-sided Cave Automatic Virtual Environment (CAVE) platform;
an image generator (110) configured to process input content and render the input contents in either two-dimensional (2D) mode or three-dimensional (3D) mode to generate interactive contents for clinical education and training;
a projection warping system (130) configured to perform a process of projection warping and blending to generate a projection warped display image; and
a video processing system (140) for processing the projection warped display image to generate a frame-synchronized display output;
wherein the immersive room comprises a surround sound system (121) for producing an audio output to the interactive contents, a motion capture system (122) for producing tracking information of a user inside the immersive room and sending the tracking information to the interactive contents, and plural projectors (125) for projecting the frame-synchronized display output from the video processing system to generate a 3D interactive image within the immersive room for clinical education and training, such that the user in the immersive room are enabled to watch and listen to the 3D interactive image and interact with the 3D interactive image and/or with each other for clinical education and training.

2. The HiVE system according to claim 1, wherein in the process of projection warping performed by the projection warping system (130), the input contents on the image generator (110) are rendered and arranged based on a physical layout of a projection surface of the projectors, and then warping is done based on the rendered display layout then further processed, rearranged, and distributed to each projector;
wherein when running the 2D mode (200) with projection warping and blending, the entirety of pixels assigned to each projector are displayed by the projector directly, and when running in the 3D mode (300), the image generator (110) render images for both the left and the right eye of the user, and arranged in side-by-side manner as final output to send to the video processing system.

3. The HiVE system according to claim 1, wherein in the immersive room, the projectors for walls are installed inside a space on a ceiling area as front, back, left, and right projectors, a set of custom-made projector cover structure (500) is installed around the projectors to conceal the projectors while allowing light from the ceiling projectors to project onto them; projectors for the ceiling (175) are installed behind the left and right walls outside of the space, an opening matching the shape of the projection light frustum is carved out on the wall for each projector to allow light to pass through while minimizing the impact to immersion; and projectors for the floor are installed on the ceiling wall and projected onto the floor through opening on the ceiling carved out in the same manner as the ceiling projectors.

4. The HiVE system according to claim 1, wherein a plurality of calibration cameras (122) are placed inside the immersive room (120) and connected to the image generator (110) to facilitate projection warping and blending.

5. The HiVE system according to claim 1, wherein to add interactivity to the system, the motion capture system (122) comprises a plurality of motion capture or sensing devices using optical or infrared light mechanism which are installed under the ceiling of the immersive room.

6. The HiVE system according to claim 1, wherein the immersive room (120) is created inside a structural room (400) using drywall, partitioning the structural room into the immersive room for the fully immersive interactive projection system and an additional room or space (401-402), wherein each side wall of the drywalls on the left and right side of the immersive room consists of two segments: a vertical lower segment (172, 174) and an internally tilted upper segment (171, 173), wherein the upper segment of the side wall is tilted inward at an angle that closely matches the light path of the bottom of the projector's projection frustum, such that the immersive room is 6-sided comprising a ceiling (175), a floor (176), two vertical segments (172, 174) and two internally tilted upper segments (171, 173).

7. The HiVE system according to claim 1, wherein the system further comprises cameras (122) for taking a 360-degree photograph of the immersion room during clinical education and training, and the projectors (125) are capable to display 360-degree images obtained in different clinical settings.

8. The HiVE system according to claim 1, wherein the system further comprises goggles (603) and handsets (605) for interacting with the 3D interactive image and with each other during clinical education and training.

9. The HiVE system according to claim 1, wherein the system comprises different teaching modes to meet different learning objectives in a teaching session during clinical education and training, wherein in one of teaching mode, the immersion room is used as a conventional class.

10. The HiVE system according to claim 1, wherein real physical objects can be placed in the immersion room, and the system integrates virtual objects (601, 602) of the 3D image and the real physical objects to facilitate realistic simulation.

11. A method for creating a Hybrid Interactive Virtual Environment (HiVE) (100), said method is configured for clinical education and training, and comprising:
forming an immersive room by a 6-sided Cave Automatic Virtual Environment (CAVE) platform so as to configure the immersive room into a fully immersive interactive hybrid classroom (120);
inputting or saving contents for clinical education and training into an image generator (110) positioned in the immersive room, wherein the image generator is configured to process the input or saved contents and render the contents in either two-dimensional (2D) mode or three-dimensional (3D) mode to generate interactive contents;
performing a process of projection warping and blending by a projection warping system (130), to generate a projection warped display image; and
processing the projection warped display image by a video processing system (140) to generate a frame-synchronized display output;
wherein the immersive room (120) comprises a surround sound system (121) for producing an audio output to the interactive contents, a motion capture system (122) for producing tracking information of a user inside the immersive room and sending the tracking information to the interactive contents, and plural projectors (125) for projecting the frame-synchronized display output from the video processing system to generate a 3D interactive image (601, 602) within the immersive room for clinical education and training, such that the user in the immersive room are enabled to watch and listen to the 3D interactive image and interact with the 3D interactive image and/or with each other for clinical education and training.

12. The method according to claim 11, wherein during the process of projection warping by the projection warping system (130), the input contents on the image generator (110) are rendered and arranged based on a physical layout of a projection surface of the projectors (125), and then warping is done based on the rendered display layout then further processed, rearranged, and distributed to each projector;
wherein when running the 2D mode (200) with projection warping and blending, the entirety of pixel assigned to each projector are displayed by the projector directly, and when running in the 3D mode (300), the image generator (110) renders images for both a left and a right eye of the user, and arranged in a side-by-side manner as final output to send to the video processing system.

13. The method according to claim 11, wherein to add interactivity to the system, the motion capture system (122) comprises a plurality of motion capture or sensing devices using optical or infrared light mechanism which are installed under the ceiling of the immersive room.

14. The method according to claim 11, further comprising using cameras to take a 360-degree photograph of the immersion room during clinical education and training, and displaying 360-degree images obtained in different clinical settings by the projectors.

15. The method according to claim 11, further comprising integrating real physical objects and virtual objects of the 3D image (601, 602) in the immersion room (120) to facilitate realistic simulation during clinical education and training.
